(19) United States
(12) Patent Application Publication
(10) Pub. No.: US 2026/0208707 A1
(43) Pub. Date: Jul. 23, 2026

(54) BRAKE SYSTEM AND CONTROL METHOD THEREOF

(71) Applicant: HL MANDO CORPORATION, Gyeonggi-do (KR)

(72) Inventors: Yongwoo LEE, Gyeonggi-do (KR); Hyojin JEONG, Gyeonggi-do (KR)

(21) Appl. No.: 19/318,345

(22) Filed: Sep. 3, 2025

(30) Foreign Application Priority Data
Jan. 20, 2025 (KR) 10-2025-0008127

(51) Int. Cl. B60T 8/17; B60T 7/04; B60T 8/1761; B60T 8/18

(52) U.S. Cl. CPC B60T 8/1708; B60T 7/042; B60T 8/17616; B60T 8/1837; B60T 8/1887; B60T 2210/20

(57) ABSTRACT

A brake system includes a vehicle electro-mechanical brake provided on a wheel of a vehicle, a vehicle electro-mechanical brake controller controlling the vehicle electro-mechanical brake, and a controller including a communication circuit, connected to the vehicle electro-mechanical brake controller through the communication circuit, and configured to transmit a first control signal for controlling the vehicle electro-mechanical brake to the vehicle electro-mechanical brake controller, and the controller is configured to be connectable to a trailer electro-mechanical brake controller controlling a trailer electro-mechanical brake provided on a wheel of a trailer coupled to the vehicle through the communication circuit, and the controller is configured to transmit a second control signal for controlling the trailer electro-mechanical brake to the trailer electro-mechanical brake controller.

### CROSS-REFERENCE TO RELATED APPLICATIONS

This application claims the priority of Korean Patent Application No. 10-2025-0008127 filed on Jan. 20, 2025, in the Korean Intellectual Property Office, the disclosure of which is incorporated herein by reference.

### BACKGROUND

### Field

The present disclosure relates to a brake system and a control method thereof.

### Description of the Related Art

Vehicles are essentially equipped with a brake system to perform braking, and with the advancement of technology, various types of brake systems are being proposed to ensure the safety of drivers and passengers.

Conventional brake systems include hydraulic brake systems that control the braking performance of each wheel of a vehicle through a hydraulic system. In addition, conventional brake systems include an electro-mechanical brake system (EMB) developed as an alternative to hydraulic brake systems. The electro-mechanical brake system may control the braking of a vehicle by operating an actuator provided at each wheel of the vehicle through an electrical signal via wiring without a hydraulic line.

Meanwhile, conventionally, when a trailer is mounted on a vehicle, a braking control logic has been developed for a vehicle's brake system that takes into account the trailer mounting. For example, conventionally, a technology has been developed in which the vehicle's brake system performs braking control on each wheel of the vehicle based on the weight of the trailer mounted on the vehicle.

However, up to now, trailers have not been equipped with brakes for dynamic braking of the trailer itself. For example, conventional trailers have parking brakes that perform the function of parking in a stationary situation, but they cannot perform that role in a dynamic braking control situation due to the absence of a hydraulic line. Accordingly, there has been a limitation that the brake system of a vehicle equipped with a trailer cannot independently control the braking of the trailer.

### SUMMARY

One aspect of the present disclosure may provide a vehicle brake system and a control method thereof capable of integrated control of an electro-mechanical brake of a vehicle and an electro-mechanical brake of a trailer mounted on the vehicle.

A brake system according to one aspect of the present disclosure includes: a vehicle electro-mechanical brake provided on a wheel of a vehicle; a vehicle electro-mechanical brake controller configured to control the vehicle electro-mechanical brake; and a controller including a communication circuit, and connected to the vehicle electro-mechanical brake controller through the communication circuit, and configured to transmit a first control signal for controlling the vehicle electro-mechanical brake to the vehicle electro-mechanical brake controller, in which the controller is configured to be connectable to a trailer electro-mechanical brake controller controlling a trailer electro-mechanical brake provided on a wheel of a trailer coupled to the vehicle through the communication circuit, and the controller may transmit a second control signal for controlling of the trailer electro-mechanical brake to the trailer electro-mechanical brake controller.

The controller may transmit the first control signal to the vehicle electro-mechanical brake controller and the second control signal to the trailer electro-mechanical brake controller based on an output signal of a pedal displacement sensor associated with the brake pedal of the vehicle.

The controller may transmit the first control signal to the vehicle electro-mechanical brake controller and the second control signal to the trailer electro-mechanical brake controller based on slip of the wheel of the vehicle.

The controller may identify occurrence of the slip of the wheel of the vehicle based on an output signal of a wheel speed sensor associated with the wheel of the vehicle.

The first control signal may include a signal for controlling the vehicle electro-mechanical brake to be re-clamped a first predetermined number of times, and the second control signal may include a signal for controlling the trailer electro-mechanical brake to be re-clamped a second predetermined number of times.

The controller may transmit the first control signal to the vehicle electro-mechanical brake controller and the second control signal to the trailer electro-mechanical brake controller based on a total weight including the vehicle and the trailer exceeding a predetermined maximum weight.

The controller may determine the total weight based on output signals of at least one sensor associated with a suspension of the vehicle to obtain information on at least one of a change in the suspension of the vehicle or a load of the vehicle, and at least one sensor associated with a suspension of the trailer to obtain information on at least one of a change in the suspension of the trailer or a load of the trailer.

The controller may determine the total weight based on a slope of a road surface on which the vehicle is located and acceleration of the vehicle, which is determined based on an output signal of the acceleration sensor, wherein the slope of the road surface is determined based on an output signal of at least one of a navigation system, a gyro sensor, an acceleration sensor, or an inertial sensor of the vehicle.

The controller may determine a slope of a road surface on which the vehicle is located based on an output signal of at least one of a navigation system, a gyro sensor, an acceleration sensor, or an inertial measurement device of the vehicle, and transmit the first control signal including information on a first target current corresponding to the determined slope of the road surface to the vehicle electro-mechanical brake controller and the second control signal including information on a second target current corresponding to the determined slope of the road surface to the trailer electro-mechanical brake controller.

The controller may determine a slope of a road surface on which the vehicle is located based on an output signal of at least one of a navigation system, a gyro sensor, an acceleration sensor, or an inertial sensor the vehicle, and transmit the first control signal including information on a first target current to the vehicle electro-mechanical brake controller and the second control signal including information on a second target current to the trailer electro-mechanical brake controller, based on a total weight including the vehicle and the trailer and the determined slope of the road surface.

A method for controlling a brake system according to one aspect of the present disclosure may include: communicationally connecting a controller of a vehicle and a trailer electro-mechanical brake controller configured to control a trailer electro-mechanical brake provided on a wheel of a trailer coupled to the vehicle; and by the controller, transmitting a first control signal for controlling a vehicle electro-mechanical brake, provided on a wheel of the vehicle, to a vehicle electro-mechanical brake controller configured to control the vehicle electro-mechanical brake and transmitting a second control signal for controlling the trailer electro-mechanical brake to the trailer electro-mechanical brake controller.

The transmitting of the first control signal and the second control signal may comprise transmitting the first control signal for controlling the vehicle electro-mechanical brake to the vehicle electro-mechanical brake controller and transmitting the second control signal for controlling the trailer brake to the trailer electro-mechanical brake controller based on an output signal of a pedal displacement sensor associated with the brake pedal of the vehicle.

The transmitting of the first control signal and the second control signal may comprise transmitting the first control signal for controlling the vehicle electro-mechanical brake to the vehicle electro-mechanical brake controller and transmitting the second control signal for controlling the trailer electro-mechanical brake to the trailer electro-mechanical brake controller based on slip of the wheel of the vehicle.

The control method may further comprise, by the controller, identifying the slip of the wheel of the vehicle based on an output signal of a wheel speed sensor associated with the wheel of the vehicle.

The first control signal may include a signal for controlling the vehicle electro-mechanical brake to be re-clamped a first predetermined number of times, and the second control signal may include a signal for controlling the trailer electro-mechanical brake to be re-clamped a second predetermined number of times.

The transmitting of the first control signal and the second control signal may comprise transmitting the first control signal for controlling the vehicle electro-mechanical brake to the vehicle electro-mechanical brake controller and transmitting the second control signal for controlling the trailer electro-mechanical brake to the trailer electro-mechanical brake controller based on a total weight including the vehicle and the trailer exceeding a predetermined maximum weight.

The method may further comprise, by the controller, determining the total weight based on output signals of at least one sensor associated with a suspension of the vehicle to obtain information on at least one of a change in the suspension of the vehicle or a load of the vehicle, and at least one sensor associated with a suspension of the trailer to obtain information on at least one of a change in the suspension of the trailer or a load of the trailer.

The method may further include, by the controller, determining the total weight based on a slope of a road surface on which the vehicle is located and acceleration of the vehicle, which is determined based on an output signal of the acceleration sensor, wherein the slope of the road surface is determined based on an output signal of at least one of a navigation system, a gyro sensor, an acceleration sensor, or an inertial sensor of the vehicle.

The method may further include, by the controller, determining a slope of a road surface on which the vehicle is located based on an output signal of at least one of a navigation system, a gyro sensor, an acceleration sensor, or an inertial sensor of the vehicle, and the transmitting of the first control signal and the second control signal may include transmitting the first control signal including information on a first target current corresponding to the determined slope of the road surface to the vehicle electro-mechanical brake controller and the second control signal including information on a second target current corresponding to the determined slope of the road surface to the trailer electro-mechanical brake controller.

The method may further include determining a slope of a road surface on which the vehicle is located based on an output signal of at least one of a navigation system, a gyro sensor, an acceleration sensor, or an inertial sensor of the vehicle, and the transmitting of the first control signal and the second control signal may include transmitting the first control signal including information on a first target current to the electro-mechanical brake controller and the second control signal including information on a second target current to the trailer electro-mechanical brake controller, based on a total weight including the vehicle and the trailer and the determined slope of the road surface.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a vehicle including a brake system according to one embodiment;

FIG. 2 is a block diagram of a trailer according to one embodiment;

FIG. 3 is a flow diagram of the operation of the brake system according to one embodiment

FIG. 4 is a flow diagram of the operation of the brake system of the vehicle according to one embodiment; and

FIGS. 5A to 5C are views illustrating a vehicle and trailer provided with an electro-mechanical brake according to one embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. The present specification does not describe all elements of the embodiments, and any content that is general in the technical field to which the present disclosure belongs or that overlaps between the embodiments is omitted. The terms “unit, module, element, block” used in the specification may be implemented in software or hardware, and according to the embodiments, a plurality of “units, modules, elements, or blocks” may be implemented as a single element, or a single “unit, module, element, or block” may include a plurality of elements.

Throughout the specification, when a part is said to be “connected” to another part, this includes not only direct connection but also indirect connection, and indirect connection includes connection via a wireless communications network.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

An embodiment of the present disclosure provides a technique for providing an electro-mechanical brake to a trailer mounted on a vehicle, in which the brake system of the vehicle can control the electro-mechanical brake of the trailer.

An embodiment of the present disclosure is to provide a technique for enabling the brake system of the vehicle to integrate control of an electro-mechanical brake of the vehicle and an electro-mechanical brake of a trailer mounted on the vehicle.

The operation principle and embodiments of the present disclosure will be described with reference to the attached drawings below.

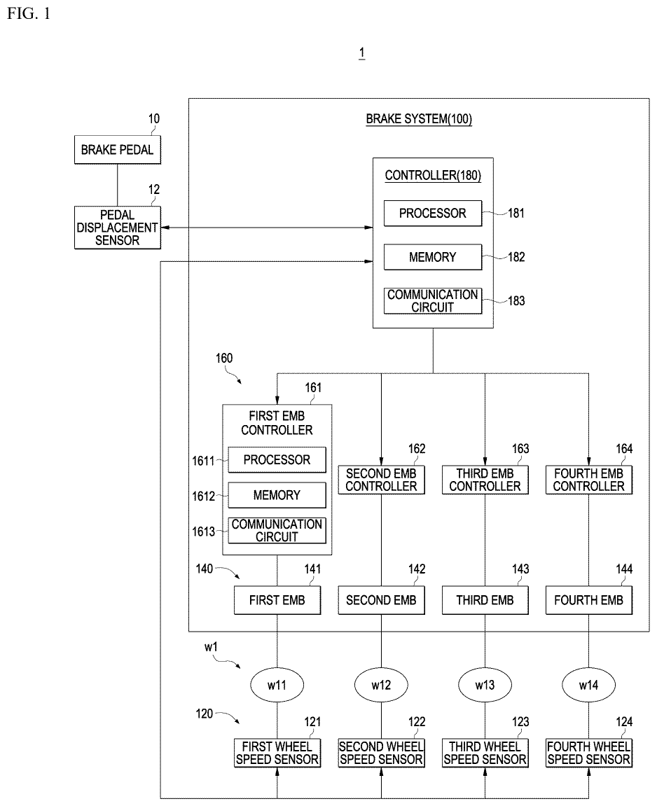

FIG. 1 is a block diagram of a vehicle including a brake system according to one embodiment.

Referring to FIG. 1, a vehicle 1 may include a brake pedal 10 for obtaining a driver's input for braking operation of the vehicle 1, a pedal displacement sensor 12 for detecting displacement of the brake pedal 10 (or obtaining displacement information), a wheel w1 that rotates so that the vehicle 1 can move, a wheel speed sensor 120 for detecting a speed of the wheel w1 (or also referred to as a rotation speed of the wheel w1), and/or a brake system 100 for braking control of the vehicle 1.

The brake pedal 10 may be provided at the lower portion of a cabin of the vehicle 1 that can be controlled by the driver's foot. The driver may step on the brake pedal 10 as a braking intention to brake the vehicle 1, and accordingly, the brake pedal 10 may move away from the reference position.

The pedal displacement sensor 12 may be physically connected to the brake pedal 10 and measure the movement of the brake pedal 10. The pedal displacement sensor 120 may detect a movement distance and/or movement speed from the reference position of the brake pedal 10.

The pedal displacement sensor 12 may be electrically connected or communicatively connected to the brake system 100 and may provide an electrical signal or a communication signal to the brake system 100.

For example, the pedal displacement sensor 12 may be directly connected to the brake system 100 via a hard wire or may be connected to the brake system 100 via a communication network. The pedal displacement sensor 12 may provide an electrical signal corresponding to the movement distance and/or movement speed of the brake pedal 10 to the brake system 100. The pedal displacement sensor 12 may be provided integrally with the brake system 100.

The wheel w1 may include a plurality of wheels, for example, a first wheel w11, a second wheel w12, a third wheel w13 and/or a fourth wheel w14.

The first wheel w11 and the second wheel w12 may be positioned on the same axle, and the third wheel w13 and the fourth wheel w14 may be located on the same axle.

For example, the first wheel w11 and the second wheel w12 may be front wheels, and the third wheel w13 and the fourth wheel w14 may be rear wheels. The first wheel w11 and the second wheel w12 may be provided on the front left and front right sides of the vehicle 1, respectively, or on the front right and front left sides of the vehicle 1, respectively. In addition, the third wheel w13 and the fourth wheel w14 may be provided on the rear left and rear right sides of the vehicle 1, respectively, or on the rear right and rear left sides of the vehicle 1.

The wheel speed sensor 120 includes a plurality of wheel speed sensors, for example, a first wheel speed sensor 121, a second wheel speed sensor 122, a third wheel speed sensor 123, and/or a fourth wheel speed sensor 124, which are provided, or installed) on each of the wheels w1 of the vehicle 1, and the first to fourth wheel speed sensors 121, 122, 123, and 124 may independently detect the speeds of the corresponding wheels, respectively.

The first wheel speed sensor 121 may be installed on the first wheel w11 and output a signal corresponding to the rotation speed of the first wheel w11. The second wheel speed sensor 122 may be installed on the second wheel w12 and output a signal corresponding to the rotation speed of the second wheel w12. The third wheel speed sensor 123 may be installed on the third wheel w13 and output a signal corresponding to the rotation speed of the third wheel w13. The fourth wheel speed sensor 124 may be installed on the fourth wheel w14 and output a signal corresponding to the rotation speed of the fourth wheel w14.

The wheel speed sensor 120 may be electrically connected or communicatively connected to the brake system 100 and may provide electrical signals or communication signals to the brake system 100.

For example, each of the first wheel speed sensor 121, the second wheel speed sensor 122, the third wheel speed sensor 123, and the fourth wheel speed sensor 124 may be directly connected to the brake system 100 via a hard wire or may be connected to the brake system 100 via a communication network. Each of the first wheel speed sensor 121, the second wheel speed sensor 122, the third wheel speed sensor 123, and the fourth wheel speed sensor 124 may provide a signal corresponding to the rotational speed of the corresponding wheel to the brake system 100.

The brake system 100 may include an electro-mechanical brake 140, also be referred to as a vehicle electro-mechanical brake, which is provided on each of the wheels w11, w12, w13, and w14 of the vehicle and is capable of generating or reducing braking force for the corresponding wheel, an electro-mechanical brake controller 160, also be referred to as a vehicle electro-mechanical brake controller, which controls the electro-mechanical brake 140, and/or a controller 180 that controls the electro-mechanical brake controller 160.

The electro-mechanical brake 140 may include a first electro-mechanical brake 141 provided on the first wheel w11 to brake or release the first wheel w11, a second electro-mechanical brake 142 provided on the second wheel w12 to brake or release the second wheel w12, a third electro-mechanical brake 143 provided on the third wheel w13 to brake or release the third wheel w13, and/or a fourth electro-mechanical brake 144 provided on the fourth wheel w14 to brake or release the fourth wheel w14.

Each of the first to fourth electro-mechanical brakes 141, 142, 143, and 144 may generate the braking force by operating with electro-mechanical force to brake the corresponding wheel, that is, by generating a clamping force through a motor and a mechanism. In addition, although not illustrated, each of the first to fourth electro-mechanical brakes 141, 142, 143, and 144 may be provided with one or more force sensors to detect the clamping force.

For example, each of the first to fourth electro-mechanical brakes 141, 142, 143, and 144 may be a caliper type or drum type brake.

The caliper type brake may include a pair of pad plates installed to pressurize a brake disc that rotates together with a corresponding wheel, a caliper housing that operates the pair of pad plates, a piston installed inside the caliper housing so as to be movable forward or rearward, a power conversion unit that receives a rotational driving force for moving the piston, converts the rotational driving force into a linear driving force, and transmits the linear driving force to the piston, a brake motor that generates a rotational driving force for moving the piston, and/or a motor driving circuit that drives the brake motor.

The drum type brake includes a pair of brake shoes having an arcuate shape and movably installed along a surface of a backing plate coupled to a vehicle body, a drum having a friction surface on an inner periphery thereof and rotating together with a corresponding wheel of the vehicle, and/or an electric actuator that applies force to each brake shoe in a direction extending the pair of brake shoes, and the electric actuator may include a motor, a reducer, a pressurizing mechanism, and/or a motor driving circuit.

The electro-mechanical brake controller 160 may include a first electro-mechanical brake controller 161 that controls the first electro-mechanical brake 141, a second electro-mechanical brake controller 162 that controls the second electro-mechanical brake 142, a third electro-mechanical brake controller 163 that controls the third electro-mechanical brake 143, and/or a fourth electro-mechanical brake controller 164 that controls the fourth electro-mechanical brake 144.

The first electro-mechanical brake controller 161 may include a processor 1611, a memory 1612 and/or a communication circuit or a communicator 1613, and may be a microcontroller unit (MCU).

The processor 1611 may process the received signal and based on the signal, transmit a control signal for braking control or braking release control of the first electro-mechanical brake 141 to the first electro-mechanical brake 141.

The memory 1612 may store or remember a program and data for implementing an operation for controlling the first electro-mechanical brake 141. The memory 1612 may provide the stored program and data to the processor 1611 and remember temporary data generated during the operation of the processor 1611.

The communication circuit 1613 may be configured to allow the first electro-mechanical brake controller 161 to transmit and/or receive signals with various components within the brake system 100. Additionally, the communication circuit 1613 may support various communication protocols (for example, controller area network (CAN), universal asynchronous receiver/transmitter (UART), inter-integrated circuit (I2C), serial peripheral interface (SPI), Ethernet, and/or recommended standard 232 (RS-232), or the like).

Although omitted in FIG. 1, each of the second electro-mechanical brake controller 162, the third electro-mechanical brake controller 163, and/or the fourth electro-mechanical brake controller 164 may include a processor, a memory, and/or a communication circuit like the first electro-mechanical brake controller 161, so that the processor, the memory, and the communication circuit may perform operations similar to the processor 1611, the memory 1612, and the communication circuit 1613 of the first electro-mechanical brake controller 161.

The controller 180 may be electrically connected or communicatively connected to the pedal displacement sensor 12, each of the wheel speed sensors 121, 122, 123, and 124, and/or each of the electro-mechanical brake controllers 161, 162, 163, and 164 to transmit and receive signals.

The controller 180 may transmit the control signal to each of the electro-mechanical brake controllers 161, 162, 163, and 164 so that each of the electro-mechanical brake controllers 161, 162, 163, and 164 performs braking control or braking release control of the corresponding wheels w11, w12, w13, and w14, based on reception of the output signal of the pedal displacement sensor 12 and/or the output signal of each of the wheel speed sensors 121, 122, 123, and 124.

The controller 180 may include a processor 181, a memory 182, and/or communication circuit 183.

The processor 181 may control the components included in the brake system 100. The processor 181 may process a received signal and transmit the control signal to each of the electro-mechanical brake controllers 161, 162, 163, and 164 based on the received signal.

The memory 182 may store or remember programs and data for implementing operations that control the components included in the brake system 100.

The memory 182 may provide stored programs and data to the processor 181 and remember temporary data generated during the operation of the processor 181.

For example, the memory 182 may include volatile memory such as static random access memory (S-RAM) and dynamic random access memory (D-RAM), and nonvolatile memory such as read only memory (ROM), erasable programmable read only memory (EPROM), electrically erasable programmable read only memory (EEPROM), and flash memory.

The communication circuit 183 may be configured to allow the controller 180 to be communicatively connected with various components within the vehicle 1 and/or the brake system 100 to transmit and/or receive signals. Additionally, the communication circuit 183 may support various communication protocols (for example, CAN, UART, I2C, SPI, Ethernet, and/or RS-232, or the like).

Meanwhile, although omitted in FIG. 1, the pedal displacement sensor 12, each of the wheel speed sensors 121, 122, 123, and 124, and/or the brake system 100 may be supplied with power through a power supply unit of the vehicle 1, for example, a battery.

In addition, a trailer may be mounted on the vehicle 1 according to the embodiment of the above-described FIG. 1. For example, when the trailer is mounted on the vehicle 1, the vehicle 1 and the trailer may be electrically connected through a connector (not illustrated), and the vehicle 1 and the trailer may be communicatively connected through a communication circuit.

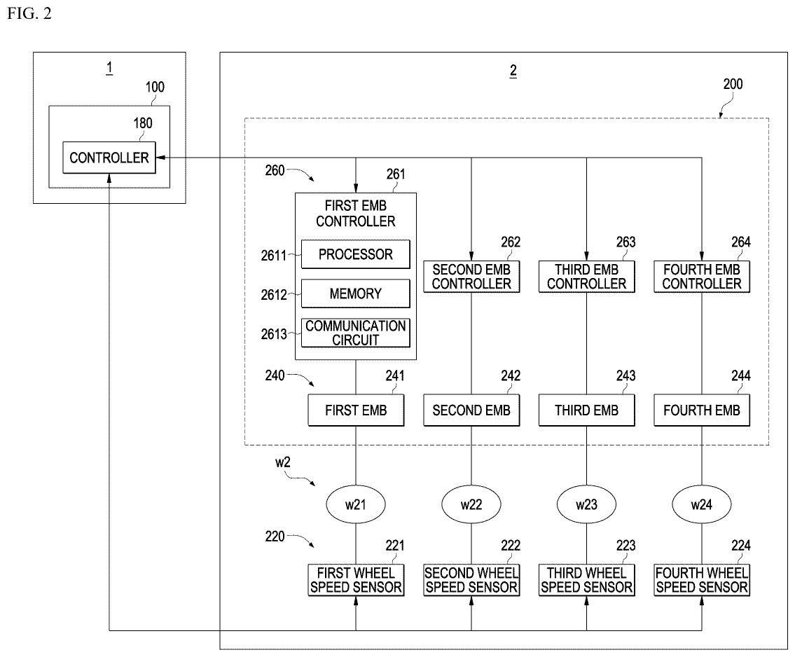

FIG. 2 is a block diagram of a trailer according to one embodiment.

Referring to FIG. 2, a trailer 2 may include a wheel w2 that rotates to allow the trailer 2 to move, a wheel speed sensor 220 that detects the speed of the wheel w2 (or also referred to as the rotation speed of the wheel w2), and/or an electro-mechanical brake system 200 for braking control of the trailer 2.

The wheel w2 may include one or more wheels, for example, a first wheel w21, a second wheel w22, a third wheel w23, and/or a fourth wheel w24.

For example, the trailer 2 may include two wheels, for example, the first wheel w21 and the second wheel w22. The first wheel w21 and the second wheel w22 may be located on the same axle. The first wheel w21 and the second wheel w22 may be provided on the left and right sides, or on the right and left sides, respectively.

As another example, the trailer 2 may include four wheels, for example, the first wheel w21, the second wheel w22, the third wheel w23, and the fourth wheel w24. The first wheel w21 and the second wheel w22 may be located on the same first axle, and the third wheel w23 and the fourth wheel w24 may be located on the same second axle. The first wheel w21 and the second wheel w22 may be front wheels, and the third wheel w23 and the fourth wheel w24 may be rear wheels. The first wheel w21 and the second wheel w22 may be provided on the front left and front right sides of the trailer 2, or may be provided on the front right and front left sides of the trailer 2, respectively. Additionally, the third wheel w23 and the fourth wheel w24 may be provided on the rear left and rear right sides of the trailer 2, or may be provided on the rear right and rear left sides of the trailer 2, respectively.

The wheel speed sensor 220 includes a plurality of wheel speed sensors, for example, a first wheel speed sensor 221, a second wheel speed sensor 222, a third wheel speed sensor 223, and/or a fourth wheel speed sensor 224, which are provided (or installed) on each of the wheels w2 of the trailer 2, and the first to fourth wheel speed sensors 221, 222, 223, and 224 may independently detect the speeds of the corresponding wheels, respectively.

The first wheel speed sensor 221 may be installed on the first wheel w21 and output a signal corresponding to the rotation speed of the first wheel w21. The second wheel speed sensor 222 may be installed on the second wheel w22 and output a signal corresponding to the rotation speed of the second wheel w22. The third wheel speed sensor 223 may be installed on the third wheel w23 and output a signal corresponding to the rotation speed of the third wheel w23. The fourth wheel speed sensor 224 may be installed on the fourth wheel w24 and output a signal corresponding to the rotation speed of the fourth wheel w24.

Each of the wheel speed sensors 221, 222, 223, and 224 may be electrically connected or communicatively connected to the vehicle 1, more specifically, to the controller 180 of the brake system 100. Accordingly, the controller 180 of the brake system 100 may receive the output signal of each of the wheel speed sensors 221, 222, 223, and 224 of the trailer 2.

The electro-mechanical brake system 200 may include an electro-mechanical brake 240 (also referred to as a trailer electro-mechanical brake) provided on each of the wheels w21, w22, w23, and w24 of the trailer 2 and capable of generating or reducing braking force on the corresponding wheel, and/or an electro-mechanical brake controller 260 (also referred to as a trailer electro-mechanical brake controller) that controls the electro-mechanical brake 240.

The electro-mechanical brake 240 may include a first electro-mechanical brake 241 provided on the first wheel w21 to brake or release the first wheel w21, a second electro-mechanical brake 242 provided on the second wheel w22 to brake or release the second wheel w22, a third electro-mechanical brake 243 provided on the third wheel w23 to brake or release the third wheel w23, and/or a fourth electro-mechanical brake 244 provided on the fourth wheel w24 to brake or release the fourth wheel w24.

Each of the first to fourth electro-mechanical brakes 241, 242, 243, and 244 may generate braking force by operating with electro-mechanical force to brake the corresponding wheel, that is, by generating a clamping force through a motor and a mechanism. In addition, although not illustrated, each of the first to fourth electro-mechanical brakes 241, 242, 243, and 244 may be provided with one or more force sensors to detect the clamping force.

For example, each of the first to fourth electro-mechanical brakes 241, 242, 243, and 244 may be a caliper type or drum type brake.

The electro-mechanical brake controller 260 may be electrically connected or communicatively connected to the controller 180 of the vehicle 1, more specifically, the brake system 100. Accordingly, the electro-mechanical brake controller 260 may receive the control signal from the controller 180 of the brake system 100 and control the electro-mechanical brake 240 based on the received control signal.

The electro-mechanical brake controller 260 may include a first electro-mechanical brake controller 261 that controls the first electro-mechanical brake 241, a second electro-mechanical brake controller 262 that controls the second electro-mechanical brake 242, a third electro-mechanical brake controller 263 that controls the third electro-mechanical brake 243, and/or a fourth electro-mechanical brake controller 264 that controls the fourth electro-mechanical brake 244.

Each of the first to fourth electro-mechanical brake controllers 261, 262, 263, and 264 may control the first to fourth electro-mechanical brakes 241, 242, 243, and 244 based on receiving the control signal from the controller 180 of the brake system 100.

The first electro-mechanical brake controller 261 may include a processor 2611, a memory 2612 and/or a communication circuit 2613, and may be a microcontroller unit.

The processor 2611 may process the received signal and based on the signal, transmit a control signal for braking control or braking release control of the first electro-mechanical brake 241 to the first electro-mechanical brake 241.

The memory 2612 may store or remember a program and data for implementing an operation for controlling the first electro-mechanical brake 241. The memory 2612 may provide the stored program and data to the processor 2611 and remember temporary data generated during the operation of the processor 2611.

The communication circuit 2613 may be configured to allow the first electro-mechanical brake controller 261 to be communicatively connected with various components within the electro-mechanical brake system 200 and the brake system 100 of the vehicle 1 to transmit and/or receive signals. Additionally, the communication circuit 2613 may support various communication protocols (for example, CAN, UART, I2C, SPI, Ethernet, and/or RS-232, or the like).

Meanwhile, although omitted in FIG. 2, each of the second electro-mechanical brake controller 262, the third electro-mechanical brake controller 263, and/or the fourth electro-mechanical brake controller 264 includes a processor, a memory, and/or a communication circuit like the first electro-mechanical brake controller 261, so that the processor, the memory, and the communication circuit may perform operations similar to the processor 2611, the memory 2612, and the communication circuit 2613 of the first electro-mechanical brake controller 261.

In addition, although omitted in FIG. 2, each of the wheel speed sensor 221, 222, 223, and 224 and/or the electro-mechanical brake system 200 may be supplied with power through a power supply unit of the vehicle 1 and/or trailer 2, for example, a battery.

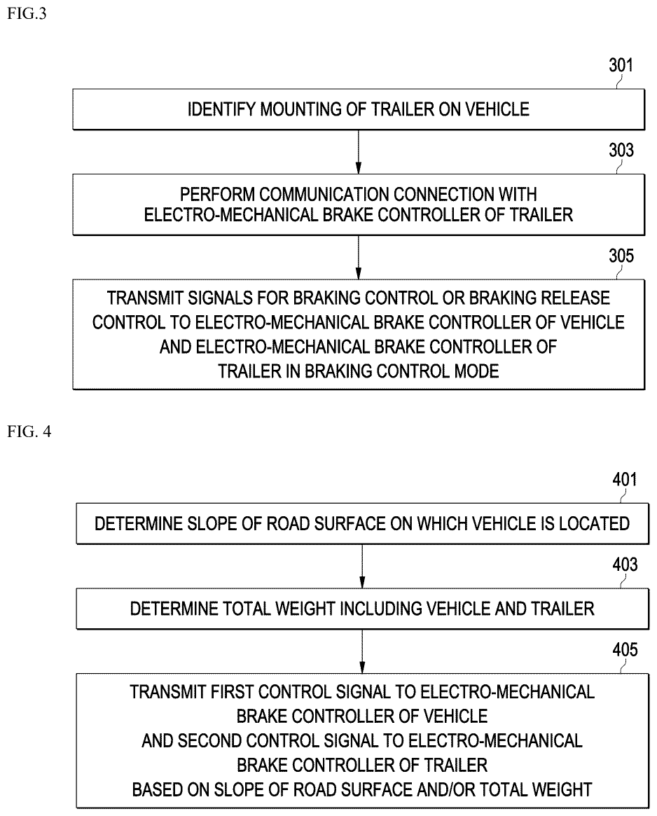

FIG. 3 is a flow diagram of the operation of a brake system 100 (and/or controller 180) according to one embodiment.

Referring to FIG. 3, the brake system 100 may identify the mounting of the trailer 2 on the vehicle 1 (301).

For example, the brake system 100 may identify that the trailer 2 is mounted on the vehicle 1 based on the identification of the electrical connection between the vehicle 1 and the trailer 2 through the connector. Alternatively, the brake system 100 may identify that the trailer 2 is mounted on the vehicle 1 based on an output signal of a sensor (not illustrated) that detects the connection of the trailer 2 provided on the vehicle 1 (for example, a load sensor capable of detecting a load on a corresponding part when the trailer is mounted on the vehicle 1 and/or a pressure sensor that detects a pressure applied to the suspension of the vehicle 1 when the trailer is mounted on the vehicle 1). In addition, the brake system 100 may identify that the trailer 2 is mounted on the vehicle 1 through one of the conventional mounting identification techniques between vehicle 1 and trailer 2.

The brake system 100 may perform a communication connection with the electro-mechanical brake controller 260 of the trailer 2 through a communication circuit 183 based on the mounting of the trailer 2 on the vehicle 1 (303).

The brake system 100 may transmit signals for braking control or braking release control to the electro-mechanical brake controller 160 of the vehicle 1 and the electro-mechanical brake controller 260 of the trailer 2 (305).

The brake system 100 may transmit the signal for braking control to the electro-mechanical brake controller 160 of the vehicle 1 and the electro-mechanical brake controller 260 of the trailer 2 based on reception of the output signal of the pedal displacement sensor 12 of the vehicle 1 and/or the output signal of the wheel speed sensor 120.

The brake system 100 may transmit a first control signal for braking control of the electro-mechanical brake 140 of the vehicle 1 to the electro-mechanical brake controller 160 of the vehicle 1 based on the output signal of the pedal displacement sensor 12 of the vehicle 1, and may transmit a second control signal for braking control of the electro-mechanical brake 240 of the trailer 2 to the electro-mechanical brake controller 260 of the trailer 2.

The brake system 100 may identify wheel slip of the vehicle 1 based on the output signal of the wheel speed sensor 120. The brake system 100 may identify the wheel slip of the trailer 2 based on the output signal of the wheel speed sensor 220.

The brake system 100 may transmit the first control signal for the braking control of the electro-mechanical brake 140 of the vehicle 1 to the electro-mechanical brake controller 160 of the vehicle 1 based on the wheel slip of the vehicle 1 and/or the trailer 2. Additionally, the brake system 100 may transmit the second control signal for the braking control of the electro-mechanical brake 240 of the trailer 2 to the electro-mechanical brake controller 260 of the trailer 2 based on the wheel slip of the vehicle 1 and/or the trailer 2.

The brake system 100 may transmit the first control signal to the electro-mechanical brake controller 160 of the vehicle 1, including a control signal for controlling the electro-mechanical brake 140 of the vehicle 1 to be re-clamped a predetermined number of times based on the wheel slip of the vehicle 1 and/or the trailer 2. In addition, the brake system 100 may transmit the second control signal to the electro-mechanical brake controller 260 of the trailer 2, including a control signal for controlling the electro-mechanical brake 240 of the trailer 2 to be re-clamped a predetermined number of times based on the wheel slip of the vehicle 1 and/or the trailer 2.

For example, the brake system 100 may transmit the first control signal including the control signal for controlling the electro-mechanical brake 140 of the vehicle 1 to be re-clamped a predetermined number of times when identifying the occurrence of wheel slip of the vehicle 1 in a state where the total weight including the vehicle 1 and the trailer 2 exceeds a predetermined maximum weight, to the electro-mechanical brake controller 160 of the vehicle 1. Moreover, the brake system 100 may transmit the second control signal including the control signal for controlling the electro-mechanical brake 240 of the trailer 2 to be re-clamped a predetermined number of times when identifying the occurrence of wheel slip of the vehicle 1 in a state where the total weight including the vehicle 1 and the trailer 2 exceeds the predetermined maximum weight, to the electro-mechanical brake controller 260 of the trailer 2.

The brake system 100 may transmit the signal for braking control to the electro-mechanical brake controller 160 of the vehicle 1 and the electro-mechanical brake controller 260 of the trailer 2, so that the electro-mechanical brake 140 of the vehicle 1 and the electro-mechanical brake 240 of the trailer 2 perform braking operations, even when the total weight including the vehicle 1 and the trailer 2 exceeds the predetermined maximum weight.

For example, the brake system 100 may apply the braking force to the vehicle 1 when the total weight including the vehicle 1 and the trailer 2 exceeds a predetermined maximum weight to prevent the vehicle 1 from moving in a state where the vehicle 1 is stopped, and at the same time, when the vehicle 1 is skidding, apply braking force again to the vehicle 1 to prevent the vehicle 1 from moving.

For example, the brake system 100 may determine the total weight including the vehicle 1 and trailer 2 through information on changes in the suspension of the vehicle 1 and trailer 2.

The brake system 100 may determine the weight of the vehicle 1 based on an output signal of at least one sensor (for example, a pressure sensor, a displacement sensor, and/or a load sensor, or the like) that is installed on the suspension (not illustrated) of the vehicle 1 and obtains information including deformation of the suspension of the vehicle 1 and/or the load of the vehicle 1. For example, the brake system 100 may determine predetermined weight information corresponding to the degree of deformation of the suspension of the vehicle 1 as the weight of the vehicle 1.

In addition, the brake system 100 may determine the weight of the trailer 2 based on an output signal of at least one sensor (for example, a pressure sensor, a displacement sensor, and/or a load sensor, or the like) that is provided on the suspension (not illustrated) of the trailer 2 and obtains the information including deformation of the suspension of the trailer 2 and/or the load of the trailer 2. For example, the brake system 100 may determine the predetermined weight information corresponding to the degree of deformation of the suspension of the trailer 2 as the weight of the trailer 2.

Additionally, the brake system 100 may determine the total weight, which is the sum of the weight of the vehicle 1 and the weight of the trailer 2.

As another example, the brake system 100 may determine the total weight including the vehicle 1 and trailer 2 based on the slope of the road surface on which the vehicle 1 is located (or also referred to as the road surface while traveling or stopped) and the acceleration of the vehicle 1.

The brake system 100 may receive output signals from a navigation system, a gyro sensor, an acceleration sensor, and/or an inertial measurement device (or also referred to as an inertial sensor) of the vehicle 1, and determine the slope of the road surface on which the vehicle 1 is located based on the received output signals.

Additionally, the brake system 100 may determine the acceleration of the vehicle 1 based on the output signal of the acceleration sensor of the vehicle 1.

In addition, the brake system 100 may determine the total weight including the vehicle 1 and the trailer 2 based on the slope of the road surface and the acceleration of the vehicle 1. For example, the brake system 100 may determine the total weight including the vehicle 1 and the trailer 2 by determining the force acting on the vehicle 1 and the trailer 2 based on the slope of the road surface and the acceleration of the vehicle 1. Determining the weight of the vehicle by analyzing the force acting on the vehicle based on the slope and the acceleration is a related art, and a detailed description thereof will be omitted.

Meanwhile, in the embodiment described above, the braking force applied to each wheel of the vehicle 1 when the trailer 2 is mounted on the vehicle 1 may be different from the braking force when the trailer 2 is not mounted on the vehicle 1. For example, when the trailer 2 is mounted on the vehicle 1, the electro-mechanical brake 140 of the vehicle 1 and the electro-mechanical brake 240 of the trailer 2 may be controlled so that braking force that additionally takes into account information such as the weight of the trailer 2 is applied to each wheel of the vehicle 1 and the trailer 2. Determining the braking force according to the mounting of the trailer 2 on the vehicle 1 is the related art, and a detailed description thereof will be omitted.

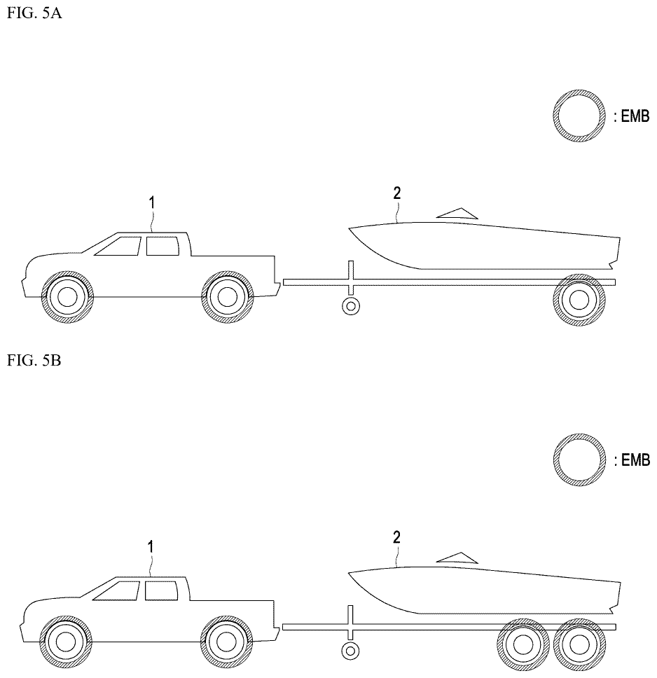

FIG. 4 is a flow diagram of the operation of the brake system 100 (and/or controller 180) of the vehicle 1 according to one embodiment.

Referring to FIG. 4, the brake system 100 may determine the slope of the road surface on which the vehicle 1 is located (401).

The brake system 100 may receive output signals from the navigation system, the gyro sensor, the acceleration sensor, and/or the inertial measurement device of the vehicle 1, and determine the slope of the road surface on which the vehicle 1 is located based on the output signals.

The brake system 100 may determine the total weight including the vehicle 1 and the trailer 2 (403).

The brake system 100 may transmit the first control signal to the electro-mechanical brake controller 140 of the vehicle 1 and the second control signal to the electro-mechanical brake controller 240 of the trailer 2 based on the determined slope and/or the determined total weight (405).

For example, the memory 182 of the brake system 100 may store the target current of each motor of the electro-mechanical brake 140 of the vehicle 1 and the electro-mechanical brake 240 of the trailer 2 for each predetermined slope.

Accordingly, the brake system 100 may identify the first target current of the motor of the electro-mechanical brake 140 and the second target current of the motor of the electro-mechanical brake 240 mapped to the determined slope among the target currents of the motors of the electro-mechanical brake 140 of the vehicle 1 and the electro-mechanical brake 240 of the trailer 2, respectively, for each predetermined slope.

The brake system 100 may transmit the first control signal including information on the first target current to the electro-mechanical brake controller 140 of a vehicle 1, and transmit the second control signal including information on the second target current to the electro-mechanical brake controller 240 of the trailer 2.

As another example, the memory 182 of the brake system 100 may store the target currents of the motors of the electro-mechanical brake 140 of the vehicle 1 and the electro-mechanical brake 240 of the trailer 2, respectively, for a predetermined slope and a predetermined total weight including the vehicle and trailer.

Accordingly, the brake system 100 may identify the first target current of the motor of the electro-mechanical brake 140 and the second target current of the motor of the electro-mechanical brake 240 mapped to the determined slope among the target currents of the motors of the electro-mechanical brake 140 of the vehicle 1 and the electro-mechanical brake 240 of the trailer 2, respectively, for the predetermined slope and the predetermined total weight including the vehicle and trailer.

The brake system 100 may transmit the first control signal including information on the first target current to the electro-mechanical brake controller 140 of the vehicle 1, and transmit the second control signal including information on the second target current to the electro-mechanical brake controller 240 of the trailer 2.

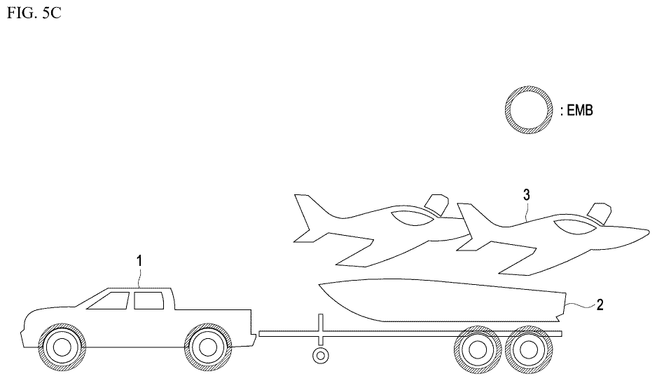

FIGS. 5A to 5C are views illustrating a vehicle and trailer provided with an electro-mechanical brake according to one embodiment.

Referring to FIGS. 5A to 5C, the electro-mechanical brakes 141, 142, 143, and 144 may be provided on the front wheels w11 and w12 and rear wheels w13 and w14 of the vehicle 1.

Referring to FIG. 5A, the trailer 2 mounted on the vehicle 1 may include one axle, and the electro-mechanical brakes may be provided on each of the left and right wheels of the one axle. Accordingly, through the embodiments described above, the brake system 100 of the vehicle 1 may perform braking control of the electro-mechanical brakes provided on each of the six wheels of the vehicle 1 and the trailer 2, and may implement dynamic stability brake control.

Referring to FIG. 5B, the trailer 2 mounted on the vehicle 1 may include two axles, and the electro-mechanical brakes may be provided on each of the left and right wheels of the two axles. Accordingly, through the embodiments described above, the brake system 100 of the vehicle 1 may perform braking control of the electro-mechanical brakes provided on each of the eight wheels of the vehicle 1 and the trailer 2, and may implement dynamic stability braking control.

Referring to FIG. 5C, the trailer 2 mounted on the vehicle 1 may include two axles, and the electro-mechanical brakes may be provided on each of the left and right wheels of the two axles. Even when a cargo 3 exceeding the maximum allowable weight specified for the trailer 2 is loaded as in FIG. 5C, the brake system 100 of the vehicle 1 may perform braking control of the electro-mechanical brakes provided on each of the eight wheels of the vehicle 1 and the trailer 2 through the above-described embodiments. For example, the brake system 100 of the vehicle 1 may perform static braking (static apply) control together with roll away re-clamp (RAR) even when the total weight of the trailer 2 exceeds the specified maximum allowable weight (over gross weight measurement (GWM)).

Meanwhile, the number and arrangement of wheels of the trailer 2 of FIG. 5A to 5C may be manufactured with various changes in embodiments.

The brake system 100 and the control method thereof according to the above-described embodiments can provide a technology capable of integrated control of the electro-mechanical brake 140 of the vehicle 1 and the electro-mechanical brake 240 of the trailer 2 mounted on the vehicle 1.

For example, the brake system 100 and the control method thereof can control the electro-mechanical brakes 140 and 240 by utilizing the brake by wire technology, so that the brake system 100 of the vehicle 1 can communicate with the controller 260 of the electro-mechanical brake 240 of the trailer 2 mounted on the vehicle 1. Accordingly, the brake system 100 of the vehicle 1 can control the braking synchronization between the vehicle 1 and the trailer 2 in real time, so as to optimize the dynamic braking performance even when the trailer 2 is mounted on the vehicle 1, and optimize the braking force distribution, thereby improving the safety and braking performance of the vehicle 1. Meanwhile, the disclosed embodiments may be implemented in the form of a recording medium that stores instructions executable by a computer. The instructions may be stored in the form of program codes, and when executed by a processor, can generate a program module to perform the operations of the disclosed embodiments. The recording medium may be implemented as a computer-readable storage medium.

Computer-readable storage media include all types of storage media that store instructions that can be deciphered by a computer. Examples include read only memory (ROM), random access memory (RAM), magnetic tape, magnetic disk, flash memory, and optical data storage devices.

A storage medium that can be read by the device may be provided in the form of a non-transitory storage medium. Here, “non-transitory” means only that the storage medium is a tangible device and does not contain signals (for example, electromagnetic waves), and this term does not distinguish between cases where data is stored semi-permanently in the storage medium and cases where data is stored temporarily. For example, a “non-transitory storage medium” may include a buffer in which data is temporarily stored.

The disclosed embodiments have been described with reference to the attached drawings as described above. Those skilled in the art will understand that the present disclosure can be implemented in forms other than the disclosed embodiments without changing the technical idea or essential features of the present disclosure. The disclosed embodiments are exemplary and should not be construed as limiting.

What is claimed is:

1. A brake system comprising:
a vehicle electro-mechanical brake provided on a wheel of a vehicle;
a vehicle electro-mechanical brake controller configured to control the vehicle electro-mechanical brake; and
a controller including a communication circuit, connected to the vehicle electro-mechanical brake controller through the communication circuit, and configured to transmit a first control signal for controlling the vehicle electro-mechanical brake to the vehicle electro-mechanical brake controller,
wherein:
the controller is configured to be connectable to a trailer electro-mechanical brake controller configured to control a trailer electro-mechanical brake provided on a wheel of a trailer coupled to the vehicle through the communication circuit, and
the controller is configured to transmit a second control signal for controlling the trailer electro-mechanical brake to the trailer electro-mechanical brake controller.

2. The brake system according to claim 1, wherein the controller is configured to transmit the first control signal to the vehicle electro-mechanical brake controller and the second control signal to the trailer electro-mechanical brake controller based on an output signal of a pedal displacement sensor associated with a brake pedal of the vehicle.

3. The brake system according to claim 1, wherein the controller is configured to transmit the first control signal to the vehicle electro-mechanical brake controller and the second control signal to the trailer electro-mechanical brake controller based on slip of the wheel of the vehicle.

4. The brake system according to claim 3, wherein the controller is configured to identify the slip of the wheel of the vehicle based on an output signal of a wheel speed sensor associated with the wheel of the vehicle.

5. The brake system according to claim 3, wherein:
the first control signal includes a signal for controlling the vehicle electro-mechanical brake to be re-clamped a first predetermined number of times, and
the second control signal includes a signal for controlling the trailer electro-mechanical brake to be re-clamped a second predetermined number of times.

6. The brake system according to claim 1, wherein the controller is configured to transmit the first control signal to the vehicle electro-mechanical brake controller and the second control signal to the trailer electro-mechanical brake controller based on a total weight including the vehicle and the trailer exceeding a predetermined maximum weight.

7. The brake system according to claim 6, wherein the controller is configured to determine the total weight based on output signals of at least one sensor associated with a suspension of the vehicle to obtain information on at least one of a change in the suspension of the vehicle or a load of the vehicle, and at least one sensor associated with a suspension of the trailer to obtain information on at least one of a change in the suspension of the trailer or a load of the trailer.

8. The brake system according to claim 6, wherein the controller is configured to determine the total weight based on a slope of a road surface on which the vehicle is located and acceleration of the vehicle, which is determined based on an output signal of the acceleration sensor, wherein the slope of the road surface is determined based on an output signal of at least one of a navigation system, a gyro sensor, an acceleration sensor, or an inertial sensor of the vehicle.

9. The brake system according to claim 1, wherein the controller is configured to:
determine a slope of a road surface on which the vehicle is located based on an output signal of at least one of a navigation system, a gyro sensor, an acceleration sensor, or an inertial sensor of the vehicle, and
transmit the first control signal including information on a first target current corresponding to the determined slope of the road surface to the vehicle electro-mechanical brake controller and the second control signal including information on a second target current corresponding to the determined slope of the road surface to the trailer electro-mechanical brake controller.

10. The brake system according to claim 1, wherein the controller is configured to:
determine a slope of a road surface on which the vehicle is located based on an output signal of at least one of a navigation system, a gyro sensor, an acceleration sensor, or an inertial sensor of the vehicle, and
transmit the first control signal including information on a first target current to the vehicle electro-mechanical brake controller and the second control signal including information on a second target current to the trailer electro-mechanical brake controller, based on a total weight including the vehicle and the trailer and the determined slope of the road surface.

11. A method for controlling a brake system, the method comprising:
communicationally connecting a controller of a vehicle and a trailer electro-mechanical brake controller configured to control a trailer electro-mechanical brake provided on a wheel of a trailer coupled to the vehicle; and
by the controller, transmitting a first control signal for controlling a vehicle electro-mechanical brake, provided on a wheel of the vehicle, to a vehicle electro-mechanical brake controller configured to control the vehicle electro-mechanical brake and transmitting a second control signal for controlling the trailer electro-mechanical brake to the trailer electro-mechanical brake controller.

12. The method according to claim 11, wherein the transmitting of the first control signal and the second control signal comprises transmitting the first control signal for controlling the vehicle electro-mechanical brake to the vehicle electro-mechanical brake controller and transmitting the second control signal for controlling the trailer brake to the trailer electro-mechanical brake controller based on an output signal of a pedal displacement sensor associated with a brake pedal of the vehicle.

13. The method according to claim 11, wherein the transmitting of the first control signal and the second control signal comprises transmitting the first control signal for controlling the vehicle electro-mechanical brake to the vehicle electro-mechanical brake controller and transmitting the second control signal for controlling the trailer electro-mechanical brake to the trailer electro-mechanical brake controller based on slip of the wheel of the vehicle.

14. The method according to claim 13, further comprising, by the controller, identifying the slip of the wheel of the vehicle based on an output signal of a wheel speed sensor associated with the wheel of the vehicle.

15. The method according to claim 13, wherein:
the first control signal includes a signal for controlling the vehicle electro-mechanical brake to be re-clamped a first predetermined number of times, and
the second control signal includes a signal for controlling the trailer electro-mechanical brake to be re-clamped a second predetermined number of times.

16. The method according to claim 11, wherein the transmitting of the first control signal and the second control signal comprises transmitting the first control signal for controlling the vehicle electro-mechanical brake to the vehicle electro-mechanical brake controller and transmitting the second control signal for controlling the trailer electro-mechanical brake to the trailer electro-mechanical brake controller based on a total weight including the vehicle and the trailer exceeding a predetermined maximum weight.

17. The method according to claim 16, further comprising, by the controller, determining the total weight based on output signals of at least one sensor associated with a suspension of the vehicle to obtain information on at least one of a change in the suspension of the vehicle or a load of the vehicle, and at least one sensor associated with a suspension of the trailer to obtain information on at least one of a change in the suspension of the trailer or a load of the trailer.

18. The method according to claim 16, further comprising, by the controller, determining the total weight based on a slope of a road surface on which the vehicle is located and acceleration of the vehicle, which is determined based on an output signal of the acceleration sensor, wherein the slope of the road surface is determined based on an output signal of at least one of a navigation system, a gyro sensor, an acceleration sensor, or an inertial sensor of the vehicle.

19. The method according to claim 11, further comprising, by the controller, determining a slope of a road surface on which the vehicle is located based on an output signal of at least one of a navigation system, a gyro sensor, an acceleration sensor, or an inertial sensor of the vehicle, and
wherein the transmitting of the first control signal and the second control signal includes transmitting the first control signal including information on a first target current corresponding to the determined slope of the road surface to the vehicle electro-mechanical brake controller and the second control signal including information on a second target current corresponding to the determined slope of the road surface to the trailer electro-mechanical brake controller.

20. The method according to claim 11, further comprising determining a slope of a road surface on which the vehicle is located based on an output signal of at least one of a navigation system, a gyro sensor, an acceleration sensor, or an inertial sensor of the vehicle,
wherein the transmitting of the first control signal and the second control signal includes transmitting the first control signal including information on a first target current to the vehicle electro-mechanical brake controller and the second control signal including information on a second target current to the trailer electro-mechanical brake controller, based on a total weight including the vehicle and the trailer and the determined slope of the road surface.
